(19) United States
(12) Patent Application Publication
(10) Pub. No.: US 2015/0248868 A1
(43) Pub. Date: Sep. 3, 2015

(54) DISPLAY DEVICE

(71) Applicant: FUNAI ELECTRIC CO., LTD., Osaka (JP)

(72) Inventor: Takehiro Mori, Osaka (JP)

(73) Assignee: FUNAI ELECTRIC CO., LTD., Osaka (JP)

(21) Appl. No.: 14/635,491

(22) Filed: Mar. 2, 2015

(30) Foreign Application Priority Data
Feb. 28, 2014 (JP) 2014-038725

(51) Int. Cl. G09G 3/36

(52) U.S. Cl. CPC G09G 3/3648; G09G 3/36; G09G 3/3614; G09G 3/3659; G09G 2300/0852; G09G 2300/0866; G09G 2310/0251; G09G 2320/0233; G09G 2320/0247; G09G 2320/0257

(57) ABSTRACT

A display panel includes a first scan line disposed in a predetermined direction of the display panel, a second scan line disposed in the predetermined direction, a first output terminal provided on one end side of the display panel in the predetermined direction and electrically connected to the first scan line, and a second output terminal provided on the other end side of the display panel in the predetermined direction and electrically connected to the second scan line.

### TECHNICAL FIELD

The present invention relates generally to a display device.

### BACKGROUND ART

In a display device, as the display screen size increases, luminance distribution on the display screen is likely to become uneven and flickering is likely to occur. For example, the number of horizontal pixels in a liquid crystal panel increases as the screen size of the liquid crystal panel increases. Therefore, the scanning signal for each pixel in the horizontal direction is susceptible to dullness. Accordingly, a gradual difference occurs in the luminance of the pixels the farther away the disposed position is from the input end of the scanning signal. Therefore, a difference occurs in the luminance between the left and right sides of the liquid crystal panel causing a difference in flicker.

Patent Document 1, for example, disposes a gate driver IC on both ends of the pixel row in the horizontal direction. Further, the dullness in the scanning signal can be supplemented by inputting the scanning signal from both ends of each pixel row at the same timing.

### DOCUMENTS OF THE RELATED ART

### Patent Documents

[Patent Document 1] Japanese Unexamined Patent Application No. H11-295696

However, in the dual side driven method used in Patent Document 1, output terminals for two gate driver IC's are connected for one pixel row. This means that, in general, more output terminals are required then with the single side driven method. Accordingly, a comparatively expensive gate driver IC having many output terminals is required, or the number of gate driver IC's must be increased. Therefore, production cost is driven up.

### SUMMARY OF THE INVENTION

A display device according to one or more embodiments of the present invention can reduce luminance difference and flicker difference in a display screen, which in turn reduces manufacturing cost.

A display device according to one aspect of the present invention has a scanning signal output unit that outputs scanning signals over a plurality of scan lines extending in a predetermined direction, wherein a plurality of pixels are connected to each scan line, the scan line is composed of first and second scan lines alternatingly disposed, and the scanning signal output unit has a first scanning signal output unit connected to the first scan line on one end side of the scan line and a second scanning signal output unit connected to the second scan line on the other end of the scan line.

According to one or more embodiments, the first scanning signal output unit is connected to a first scan line on one end of the scan line. Meanwhile, the second scanning signal output unit is connected to a second scan line on the other end. Therefore, the scanning signal is output from one end to the other end on the first scan line and then output from the other end to one end on the second scan line. Therefore, even if dullness occurs in the scanning signal output over the scan line, the luminance difference generated in pixels connected to the first scan line is offset by the luminance difference generated in pixels connected to the second scan line. Therefore, overall luminance difference and flicker difference for a plurality of pixels can be reduced in a predetermined direction that the scan lines extend. Further, because one scan line is connected to a first or second scanning signal output unit, the number of output terminals in the scanning signal output unit does not need to be increased. Thus, manufacturing costs can be reduced.

Further, in the display device according to one or more embodiments, a scanning signal control unit may output a scanning signal to the first scan line for each odd numbered synchronization cycle and may output the scanning signal to the second scan line for each even numbered synchronization cycle.

According to one or more embodiments, pixels connected to the first scan line and the pixels connected to the second scan line are scanned in an alternating timing. Accordingly, the luminance difference in pixels generated in a predetermined direction that the scan lines extend becomes more easily offset. Therefore, overall luminance difference and flicker difference for a plurality of pixels can be more effectively reduced.

In the display device according to one or more embodiments, a plurality of pixels may be configured to be disposed on both sides in a direction orthogonal to a predetermined direction on each scan line in a planar view when viewing the plurality of pixels from a normal direction.

According to one or more embodiments, pixels scanned by a dull scanning signal and pixels scanned by a not dull scanning signal can be arranged dispersed in a direction orthogonal to the scan line. Therefore, uniformity can be facilitated in overall luminance difference in pixels.

Further, in the display device according to one or more embodiments, the first scan line and the second scan line may be configured to be alternatingly disposed every other one.

According to one or more embodiments, the luminance difference caused by dullness occurring in the scanning signal in a predetermined direction that the scan lines extend can be more easily offset. Therefore, overall luminance difference and flicker difference for a plurality of pixels can be reduced or prevented in the predetermined direction.

Additionally, in the display device according to one or more embodiments, a plurality of pixels may be configured to be alternatingly disposed, respectively, on both sides in a direction orthogonal to a predetermined direction on each scan line in a planar view when viewing the plurality of pixels from a normal direction.

According to one or more embodiments, the pixels connected to each scan line are disposed in a staggered pattern. Accordingly, because crosstalk does not readily occur between adjacent pixels, shadowing can be more effectively reduced in a plurality of pixels. Additionally, pixels scanned by a dull scanning signal and pixels scanned by a not dull scanning signal can be arranged more dispersed in a direction orthogonal to the scan line. Therefore, drops in luminance generated at one end side and the other end side are uniform. Therefore, overall luminance difference and flicker difference in a predetermined direction that the scan lines extend can be reduced.

A display panel according to another aspect of the present invention comprises a first scan line disposed in a predetermined direction of the display panel; a second scan line disposed in the predetermined direction; a first output terminal provided on one end side of the display panel in the predetermined direction and electrically connected to the first scan line; and a second output terminal provided on the other end side of the display panel in the predetermined direction and electrically connected to the second scan line.

A display module according to another aspect of the present invention comprises a display panel, the display panel comprising a first scan line disposed in a predetermined direction of the display panel; a second scan line disposed in the predetermined direction; a first output terminal provided on one end side of the display panel in the predetermined direction and electrically connected to the first scan line; and a second output terminal provided on the other end side of the display panel in the predetermined direction and electrically connected to the second scan line; and a scanning signal controller that controls output of scanning signals to the first output terminal and the second output terminal in an aligned sequence of the first scan line and the second scan line.

A display device according to another aspect of the present invention comprises a light source; and a display module comprising a display panel, the display panel comprising a first scan line disposed in a predetermined direction of the display panel; a second scan line disposed in the predetermined direction; a first output terminal provided on one end side of the display panel in the predetermined direction and electrically connected to the first scan line; and a second output terminal provided on the other end side of the display panel in the predetermined direction and electrically connected to the second scan line.

A display device according to one or more embodiments of the present invention can reduce luminance difference and flicker difference in a display screen and also lower manufacturing costs.

### BRIEF DESCRIPTION OF DRAWINGS

FIG. 1 is an external view of a liquid crystal display according to one or more embodiments of the present invention.

FIG. 2 is a block diagram illustrating a liquid crystal display according to one or more embodiments of the present invention.

FIG. 3 is an enlarged view of a pixel array according to one or more embodiments of the present invention as viewed from a normal direction.

FIG. 4 is a timing chart of the clock signal and scan signal for each scan according to one or more embodiments of the present invention.

FIG. 5 is an enlarged view of a pixel array according to one or more embodiments of the present invention as viewed from a normal direction.

FIG. 6 is a timing chart of the clock signal and scan signal for each scan according to one or more embodiments of the present invention.

FIG. 7 is a timing chart of the clock signal and scan signal for each scan according to one or more embodiments of the present invention.

### DETAILED DESCRIPTION OF THE EMBODIMENTS

Embodiments of the present invention will be described hereinafter with reference to figures.

### FIRST EXAMPLE

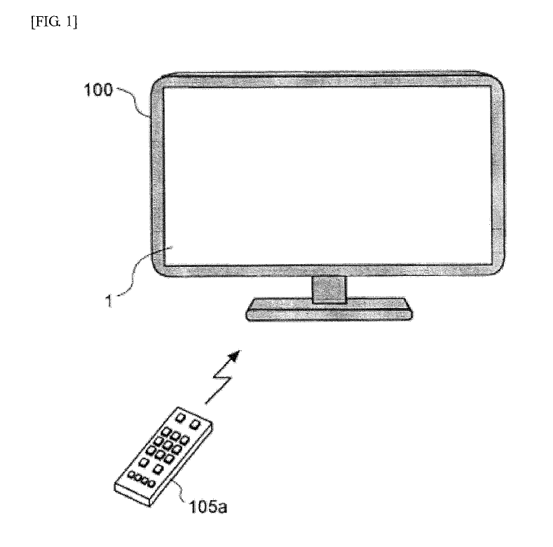

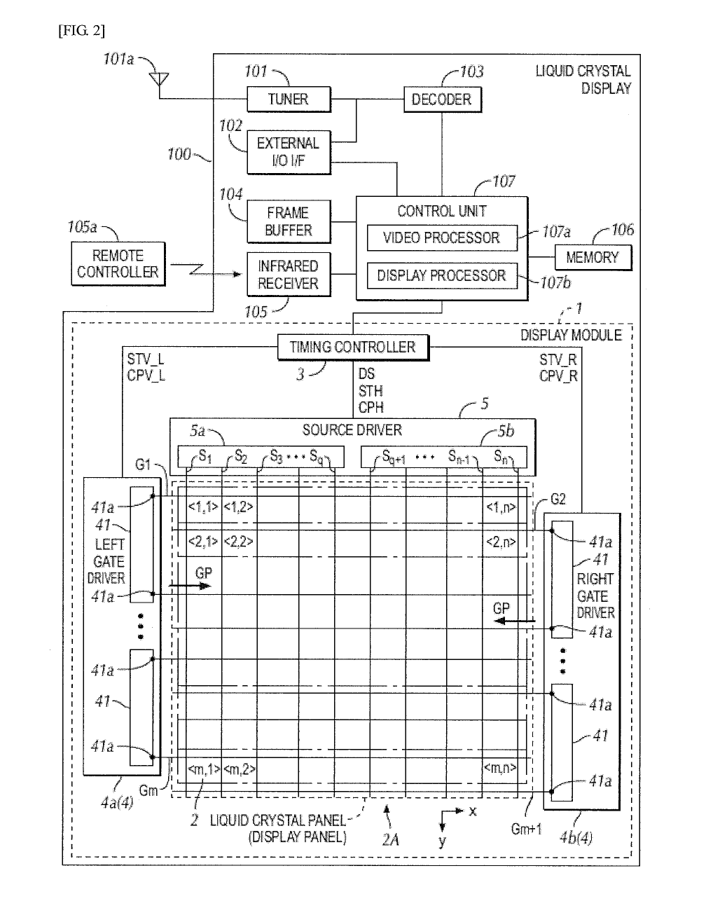

FIG. 1 is an external view of a liquid crystal display according to one or more embodiments of the present invention. FIG. 2 is a block diagram illustrating a liquid crystal display according to one or more embodiments of the present invention. A liquid crystal display 100 is a video display device that displays video images on a liquid crystal panel included in a display module 1. The liquid crystal display 100 includes a tuner 101, and external input-output I/F 102, a decoder 103, a frame buffer 104, an infrared receiver 105, in memory 106, a control unit 107, and a display module 1.

The tuner 101 is a receiver that receives broadcast signals via an antenna 101 a of various channels broadcast from a broadcasting station. The tuner 101 separates a video signal from the broadcast signal using a demodulation process or the like and outputs this to a decoder 103.

The external input-output interface (I/F) 102 is an external communication unit that can connect wirelessly or by cable to an external device. The external input-output I/F 102 accepts information (video information, control information, and the like) input from an external device such as a Blu-ray Disc (BD) recorder or the like. Further, the external input-output I/F 102 outputs a signal based on such information to the decoder 103 or to the control unit 107. Moreover, the external input-output I/F 102 outputs the output signal from the control unit 107 to an external device.

The decoder 103 decodes the video signal input from the tuner 101 or the external input-output I/F 102.

The frame buffer 104 is a volatile storage medium that stores appointed video data one frame at a time for display by the liquid crystal panel.

The infrared receiver 105 receives an infrared signal output from a remote controller 105a and outputs a user input signal to the control unit 107 based on the infrared signal. The remote controller 105a is an external input unit that accepts user input.

Memory 106 is a nonvolatile storage medium that stores, for example, a variety of programs and information used by the control unit 107.

The control unit 107 controls various configuration elements of the liquid crystal display 100 using the programs and information, and the like, stored in the memory 106. The control unit 107 includes a video processor 107a and a display control unit 107b.

The video processor 107a generates video data to display on the liquid crystal panel based on the decoded video signal. The generated video data is stored in the frame buffer 104. Further, the video processor 107a reads the video data in single frame increments from the frame buffer 104.

The display control unit 107b controls the display operation of the display module 1 by outputting control signals to the display module 1. Further, the display control unit 107b generates signals based on the video data of a single frame portion read by the video processor 107a and outputs this to the display panel 1.

The display module 1 is a display device that displays images based on signals output from the display control unit 107b. The display module 1 includes an active-matrix drive type pixel array 2A, a timing controller 3, a gate driver 4, a source driver 5, and a backlight unit (not illustrated) as a light source for the pixel array 2A.

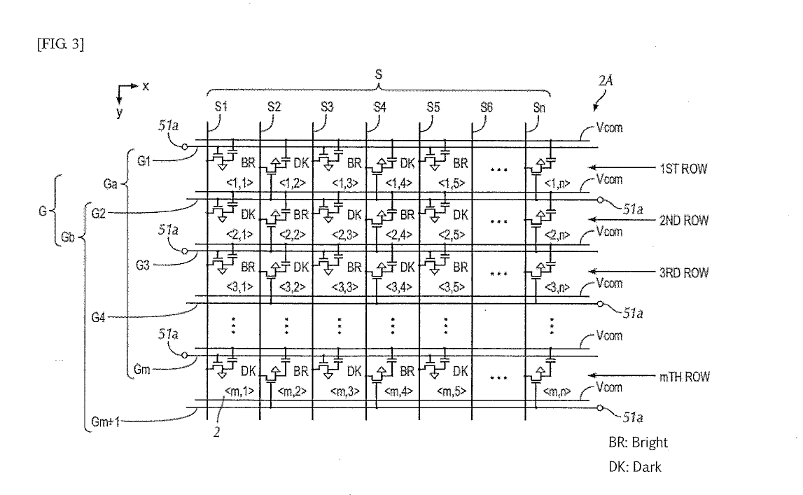

The pixel array 2A includes a plurality of pixels 2 disposed in a matrix of m rows×n columns (both m and n being positive integers of 2 or greater). With the pixel array 2A, a liquid crystal material (not illustrated) is sealed between two glass substrates (not illustrated). (m+1) number of scan lines G1 to Gm+1, a plurality of reference potential lines Vcom (see FIG. 3 described below), and n number of data lines S1 to Sn are formed on the inner side of one of the glass substrates. As described below, scanning signals GP are output to the scan lines G1 to Gm+1, and drive voltage signals are output to the data lines S1 to Sn. The (m+1) number of scan lines G1 to Gm+1 may be collectively referred to as scan line G, and the n number of data lines S1 to Sn may be collectively referred to as data line S.

The scan line G and the reference potential line Vcom extend in one direction (row direction x of the pixel array 2A). The data line S extends orthogonal to the scan line G in a direction parallel to one of the glass substrates (column direction y of the pixel array 2A). At each portion where the scan line G crosses the data line S, a switching circuit (see FIG. 3 described below) that includes a Thin Film Transistor (TFT) element is formed. A transparent electrode (not illustrated) is connected to the switching circuit. At each portion, the gate of the switching circuit is connected to the scan line the source is connected to the data line S, and the drain is connected to the reference potential line Vcom via capacitive element. Meanwhile, the transparent electrode (not illustrated) is connected to the inner side of the other glass substrate.

FIG. 3 is an enlarged view of a pixel array according to one or more embodiments of the present invention as viewed from a normal direction. In FIG. 3 (and in other figures), x indicates the row direction of the pixel array 2A (for example, the horizontal direction in FIG. 3). Further, y indicates a column direction orthogonal to the row direction x (for example, the vertical direction in FIG. 3). With a pixel array 2A, odd numbered pixels 2 counting in order from the left gate driver 4a side (left side in FIG. 3) from among the pixels 2 in the (p-1) numbered row and even numbered pixels 2 from among the pixels 2 of the p row are connected to the scan line Gp of the p (p being a positive integer of 2 or more and m or less) numbered row.

That is, in FIG. 3, each of the scan lines G have a plurality of pixels 2 on both sides in the column direction y in a planar view when viewing the pixel array 2A from a normal direction. This means that the pixels 2 scanned by a dull scanning signal GP and the pixels 2 scanned by a not dull scanning signal GP can be arranged dispersed in the column direction y. Therefore, uniformity can be facilitated in the overall luminance difference in the pixel array 2A.

Further, in FIG. 3, in the above planar view, each of the scan lines G have a plurality of pixels 2 alternatingly disposed, respectively, on both sides in the column direction y. Therefore, the pixels 2 connected to each scan line G are disposed in a staggered pattern. Accordingly, because crosstalk does not readily occur between adjacent pixels 2, shadowing can be more effectively reduced in the pixel array 2A. In addition, even if dullness occurs in the scanning signal GP output to the scan line G, the pixels 2 scanned by a dull scanning signal GP and the pixels 2 scanned by a not dull scanning signal GP can be arranged more dispersed in the column direction y. Therefore, drops in the luminance generated at the left end side and the right end side of the pixel array 2A are uniform. Therefore, overall luminance difference and flicker difference in the row direction x that the scan line G extends can be reduced.

The odd numbered pixels 2 from among the pixels 2 in the first row are connected to the scan line G1 of the first row. The even numbered pixels 2 from among the pixels 2 in the m row are connected to the scan line Gm+1 of the (m+1) row.

The timing controller 3 is a signal control unit (a scanning signal controller) that controls signal output of the gate driver 4 and the source driver 5. The timing controller 3 generates a data signal DS and display control data based on signals output from the display control unit 107b (for example, a signal corresponding to a video data and a reference clock signal CLK). The display control data includes, for example, first and second scanning start signals STV_L, STV_R, first and second scanning clock signals CPV_L, CPV_R, a source start signals STH, and a source clock signal CPH, and the like. The timing controller 3 outputs the first and second scanning start signals STV_L, STV_R and the first and second scanning clock signals CPV_L, CPV_R to the gate driver 4. In this manner, the timing controller 3 also functions as a scanning signal controller to control the gate driver 4 that outputs the scanning signal GP to the scan line G. Further, the timing controller 3 outputs the data signal DS, the source start signal STH, and the source clock signal CPH to the source driver 5.

The gate driver 4 is a scanning signal output unit that outputs the scanning signal GP to the scan line G. The gate driver 4 selects pixels 2 in the row direction x for scanning in accordance with the output of the scanning signal GP to the scan line G. The switching circuit (particularly the TFT element in FIG. 3) connecting the pixel 2 to the data line S is driven On with the selected pixel 2. The unselected pixel is driven Off by the switching circuit.

The gate driver 4 comprises a left gate driver 4a (first gate driver) and a right gate driver 4b (second gate driver). The left gate driver 4a and the right to gate driver 4b respectively include a plurality of gate driver IC's 41. In addition, the scan line G is electrically connected to the output terminal 41a of each gate driver IC 41. For example, the odd numbered scan lines G1, G3, . . . , Gm counting in order from the source driver 5 side (top side in FIG. 3) are respectively connected to the output terminals 41a of the left gate driver 4a on the left end side of the scan line G. Further, the even numbered scan lines G2, G4, . . . , Gm+1 are respectively connected to the output terminals 41a of the right gate driver 4b on the right end side of the scan line G. The scan lines G1, G3, . . . , Gm connected to the left gate driver 4a are referred to below as the first scan lines Ga. The scan lines G2, G4, . . . Gm+1 connected to the right gate driver 4b are referred to below as the second scan lines Gb.

When configuring in this manner, the scanning signal GP is output from the left end to the right end on the first scan line Ga and then output from the right end to the left end on the second scan line Gb. Therefore, even if dullness occurs in the scanning signal GP output over the scan line the luminance difference generated in pixels 2 connected to the first scan line Ga is offset by the luminance difference generated in pixels 2 connected to the second scan line Gb. Therefore, overall luminance difference and flicker difference for a plurality of pixels 2 (i.e. the pixel array 2A) can be reduced in the row direction x that the scan line G extends. Further, because once scan line G is connected to the left gate driver 4a or the right gate driver 4b, the number of output terminals 41a in the gate driver 4 does not need to be increased. Thus, manufacturing costs can be reduced.

Furthermore, as illustrated in FIG. 3, the first scan line Ga and the second scan line Gb are alternatingly disposed every other one. Therefore, when the scanning signal GP is output to the scan line the luminance difference caused by dullness occurring in the scanning signal GP in the row direction x that the scan lines G extend can be more easily offset. Therefore, overall luminance difference and Flicker difference in the pixel array 2A can be reduced or prevented in the row direction x.

Next, the source driver 5 is a voltage signal output unit that outputs a drive voltage signal to the data line S in accordance with the data signal DS. The source driver 5 includes two source driver IC's 5a and 5b. Data signal lines S1 to Sq are connected to the source driver IC 5a. Here, q is an integer of 1 or greater or (n/2) or less. The drive voltage signal output to the data signal lines S1 to Sq correspond to the video data displayed in the region of the left half of the pixel array 2A (i.e. pixels 2 in the first to the qth columns). Meanwhile, the data signal lines Sq+1 to Sn are connected to the source driver IC 5b. The drive voltage signal input to the data signal lines Sq+1 to Sn correspond to the video data displayed in the region of the right half of the pixel array 2A (i.e. pixels 2 in the q+1 to the nth columns).

As such, outputting the drive voltage signal using the two source driver IC's 5a and 5b allows the time period for outputting the drive voltage signal to all of the data lines is cut in half compared to when using one source driver IC. Therefore, operating frequency of each source driver IC 5a and 5b can be lower.

Each source driver IC 5a and 5b outputs a drive voltage signal in the order of each data line S1 to Sq, Sq+1 to Sn at a timing in accordance with each pulse of the source clock signal CPH after startup of the source start signal STH. At that time, the drive voltage or the off voltage (for example OV) is applied in order of each pixel 2 scanned by the gate driver 4 to make the luminance a predetermined value.

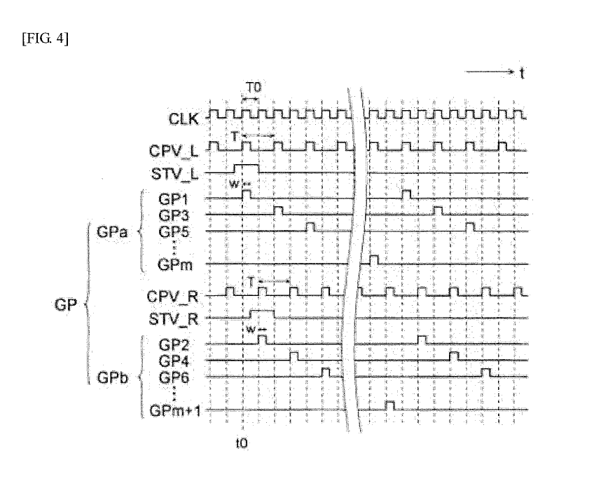

Next, a description will be given of the output timing of the scanning signal GP. FIG. 4 is a timing chart of the clock signal and scan signal for each scan according to one or more embodiments of the present invention. As illustrated in FIG. 4, the first scan clock signal CPV_L is made up of the odd numbered pulses of the reference clock signal CLK counting from the time tO. Meanwhile, the second scan clock signal CPV_R is made up of the even numbered pulses of the reference clock signal CLK. That is the first clock signal CPV _L and the second clock signal CPV_R are made up of every other pulse of the reference clock signal CLK. Therefore, the time period T for each pulse of the first clock signal CPV_L and the second clock signal CPV_R to start out is twice that of the time period TO of the reference clock signal CLK. Additionally, the start of the pulses of the first clock signal CPV_L and the second clock signal CPV_R are mutually off by a single time period TO of the reference clock signal CLK.

Subsequent to the startup of the first scan start signal STV_L, the scanning signals GP1, GP3, . . . , GPm are output in sequence to the first scan line Ga at a timing in accordance with each pulse of the first scan clock signal CPV_L. Moreover, subsequent to the startup of the second scan start signal STV_R, the scanning signals GP2, GP4, . . . , GPm+1 are output in sequence to the second scan line Gb at a timing in accordance with each pulse of the second scan clock signal CPV_R. The scanning signals GP1, GP3, . . . , GPm output to the first scan line Ga may be referred to below as the first scanning signal GPa. Further, the scanning signals GP2, GP4, . . . , GPm+1 output to the second scan line Gb may be referred to below as the second scanning signal GPa.

As illustrated in FIG. 4, the first scanning signal GP is output to the first scan line Ga at each odd numbered synchronization cycle (i.e. the startup timing of the pulse of the reference clock signal CLK) by the first clock signal CPV_L output from the timing controller 3. Further, the second scanning signal GPb is output to the second scan line Gb at each even numbered synchronization cycle according to the second clock signal CPV_R.

By doing so, the pixels 2 connected to the first scan line Ga and the pixels 2 connected to the second scan line Gb are scanned in an alternating timing. Accordingly, the luminance difference in pixels 2 generated in the row direction x that the scan lines G extend becomes more easily offset. Therefore, overall luminance difference and flicker difference for the pixel array 2A can be more effectively reduced.

### SECOND EXAMPLE

Next, a description of embodiments of the second example will be given below. In one or more embodiments of the second example, the first scan line Ga connected to the left gate driver 4a and the second scan line Gb connected to the right gate driver 4b are disposed mutually adjacent every other plurality. The configuration differing from the embodiments of the first example will be described below. In addition, configuration elements that are similar to the embodiments of the first example will be given the same reference number and descriptions thereof are omitted.

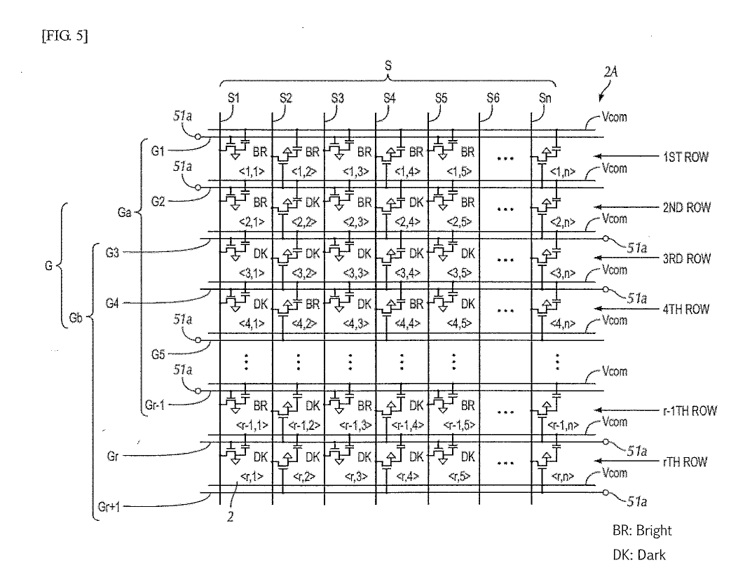

FIG. 5 is an enlarged view of a pixel array according to one or more embodiments of the present invention as viewed from a normal direction. In the configuration example illustrated in FIG. 5, the pixel array 2A includes a plurality of pixels 2 disposed in a matrix of r rows×n columns (r being a positive integer of 4 or greater). Furthermore, the first scan line Ga and the second scan line Gb are disposed mutually adjacent every other two. For example, the first scan lines G1, G2, . . . , Gr-3, Gr-2 are respectively connected to the output terminals 41a of the left gate driver 4a on the left end side of the scan line G. Second scan lines G3, G4, . . . , Gr-1, Gr are respectively connected to the output terminals 41a of the right gate driver 4b on the right end side of the scan line G.

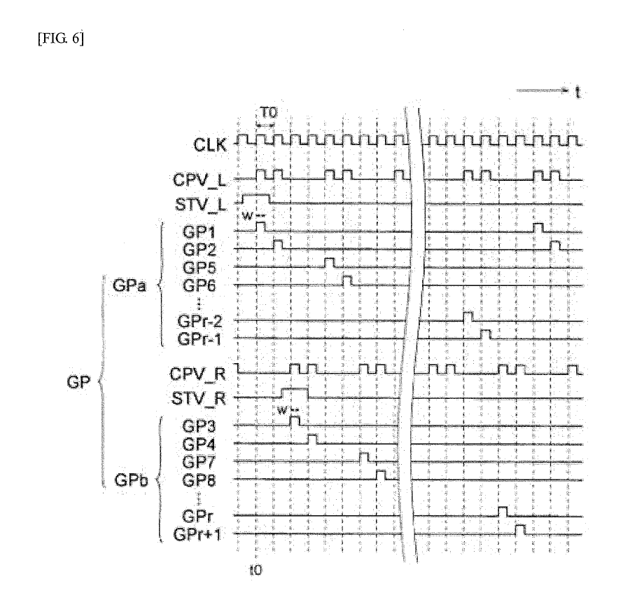

FIG. 6 is a timing chart of the clock signal and scan signal for each scan according to one or more embodiments of the present invention. As illustrated in FIG. 6, the first scan clock signal CPV_L is made up of the (r-3) numbered and (r-2) numbered pulses of the reference clock signal CPV counting from the time tO. As described above, r is an integer of 4 or greater. Meanwhile, the second scan clock signal CPV_R is made up of the (r-1) numbered and r numbered pulses of the reference clock signal CPV. That is, the first clock signal CPV_L and the second clock signal CPV_R are made up of every other two pulses of the reference clock signal CLK.

The left gate driver 4a, subsequent to the startup of the first scan start signal STV_L, outputs the first scanning signals GP1, GP2, . . . , GPr-3, GPr-2 in sequence to the first scan line Ga at a timing in accordance with each pulse of the first scan clock signal CPV_L. Further, the right gate driver 4b, subsequent to the startup of the second scan start signal STV_R, outputs the second scanning signals GP3, GP4, . . . , GPr-1, GPr in sequence to the second scan line Gb at a timing in accordance with each pulse of the second scan clock signal CPV_R.

When configuring in this manner, the scanning signal GP is output from the left end to the right end on the first scan line Ga and then output from the right end to the left end on the second scan line Gb. Further, the pixels 2 connected to the first scan line Ga and the pixels 2 connected to the second scan line Gb are scanned in an alternating timing. Therefore, even if dullness occurs in the scanning signal GP, and although the extent may be considered inferior compared to the embodiments of the first example, the luminance difference generated in pixels 2 connected to the first scan line Ga is offset by the luminance difference generated in pixels 2 connected to the second scan line Gb. Therefore, overall luminance difference and flicker difference for the pixel array 2A can be reduced in the row direction x that the scan line G extends.

In this embodiment, the alternating displacement of the first scan line Ga and the second scan line Gb is placed every other two, but the example is not limited to this. The first scan line Ga and the second scan line Gb alternatingly disposed may be disposed mutually adjacent every other plurality of three or more. Even with such configuration, reduction of overall luminance difference and flicker difference for the pixel array 2A is possible.

### THIRD EXAMPLE

Next, a description of embodiment of the third example will be given below. In the pixel array 2A as described in the embodiments of the first and second examples, the overall luminance is lower compared to when all of the first row portion of pixels 2 are connected to one scan line G. Therefore, a user is left feeling that the display screen of the liquid crystal panel is slightly darker. In order to supplement the dropping of this type of luminance, in one or more embodiments of the third example, a scanning period Wa of a one pulse portion of the scanning signal GP (the time for the scanning signal GP to turn On) is longer than the scanning period of the embodiments of the first and second examples (for example, see FIG. 4). The configuration differing from the embodiments of the first and second examples will be described below. In addition, configuration elements that are similar to the embodiments of the first example will be given the same reference number and descriptions thereof are omitted.

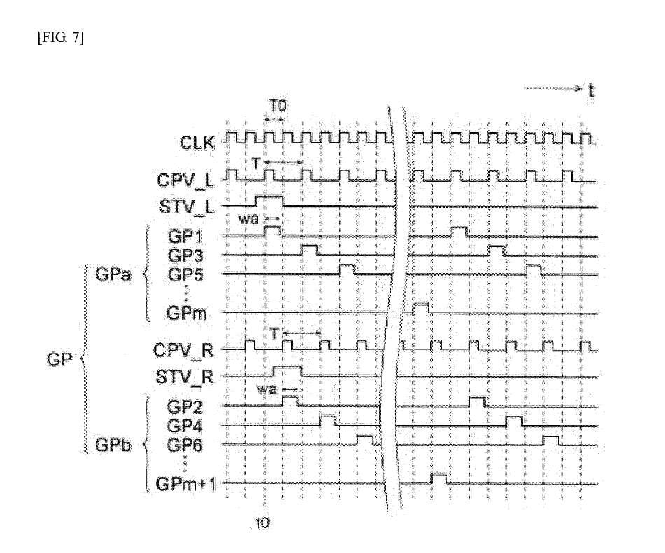

FIG. 7 is a timing chart of the clock signal and scan signal for each scan according to one or more embodiments of the present invention. As illustrated in FIG. 7, the left gate driver 4a and the right gate driver 4b output the scanning signals GP1 to GPm+1 at the same timing as the embodiments of the first example (see FIG. 4). However, the scanning time Wa for each scanning signal GP is shorter than one cycle TO of the reference clock signal CLK, but it is longer than the scanning time w in the embodiments of the first and second examples (w<wa<TO). Such a configuration allows the drive time by the source driver 5 for each pixel 2 to be longer thereby increasing the luminance of each pixel 2. Therefore, the overall luminance in the pixel array 2A can be increased.

Configurations other than the example given in FIG. 7 are also possible for supplementing the drop in overall luminance in the pixel array 2A. For example, the luminance of the backlight unit (not illustrated) may be increased, or the drive voltage supplied to each pixel 2 from the source driver 5 may be increased.

The above embodiments of the present invention have been described. The embodiments as described above are examples, and it is understood by a person skilled in the art that various modifications are possible to each element of configuration and combination of processes and such is included in the scope of the present invention.

For example, in one or more embodiments of the first to third examples described above, the pixels 2 connected to the first scan line Ga and the pixels 2 connected to the second scan line Gb are disposed mutually adjacent every other one in the row direction x of the pixel array 2A, but the applicable scope of the present invention is not limited to this example. The pixels adjacent in the row direction x of the pixel array 2A may be connected to different scan lines alternating a predetermined number at a time. Furthermore, the predetermined number may be one-half of the number of the pixels aligned in the row direction x of the pixel array 2A. Even with such configuration, the pixel 2 scanned by a dull scanning signal GP and the pixel 2 scanned by a not dull scanning signal GP can be arranged dispersed in a direction orthogonal to the scan line G. Therefore, uniformity can be facilitated in the overall luminance difference in the pixel array 2A.

In the embodiments described above, inputs of the source driver at the data line side may be alternately provided up-and-down.

Further, in the embodiments of the first to third examples described above, at least a portion from among each functional element of the control unit 107 may be realized by a physical configuration element (for example, an electrical circuit, device, and the like).

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF THE NUMERICAL REFERENCES

100 liquid crystal display
101 tuner
101a antenna
102 external input-output I/F
103 decoder
104 frame buffer
105 infrared receiver
105a remote controller
106 memory
107 control unit
107a video processor
107b display control unit
1 display module
2 pixel
2 A pixel array
3 timing controller
4 gate driver
4a left gate driver
4b right gate driver
41 gate driver IC
41a output terminal
5 source driver
51a, 51b source driver IC

What is claimed is:

1. A display panel comprising:
a first scan line disposed in a predetermined direction of the display panel;
a second scan line disposed in the predetermined direction;
a first output terminal provided on one end side of the display panel in the predetermined direction and electrically connected to the first scan line; and
a second output terminal provided on the other end side of the display panel in the predetermined direction and electrically connected to the second scan line.

2. The display panel according to claim 1,
wherein the first scan line and the second scan line are disposed one line at a time, respectively.

3. The display panel according to claim 1, wherein
the first scan line and the second scan line are disposed two lines at a time, respectively.

4. The display panel according to claim 1, wherein
the first scan line and the second scan line are disposed in a predetermined number of lines at a time, respectively.

5. The display panel according to claim 1, further comprising:
a plurality of pixels aligned in the predetermined direction, the plurality of pixels being connected to one of either adjacent scan line.

6. The display panel according to claim 5, wherein
pixels adjacent in the predetermined direction are connected to respectively different scan lines.

7. The display panel according to claim 5, wherein
pixels adjacent in the predetermined direction are connected to different scan lines alternating a predetermined number at a time.

8. The display panel according to claim 7, wherein
the predetermined number is half the number of pixels aligned in the predetermined direction.

9. A display module comprising:
a display panel, the display panel comprising:
a first scan line disposed in a predetermined direction of the display panel;
a second scan line disposed in the predetermined direction;
a first output terminal provided on one end side of the display panel in the predetermined direction and electrically connected to the first scan line; and
a second output terminal provided on the other end side of the display panel in the predetermined direction and electrically connected to the second scan line; and
a scanning signal controller that controls output of scanning signals to the first output terminal and the second output terminal in an aligned sequence of the first scan line and the second scan line.

10. The display module according to claim 9, further comprising:
a first gate driver that outputs a scanning signal to the first output terminal based on control by the scanning signal controller, wherein
the first gate driver is disposed on the one end side.

11. The display module according to claim 10, further comprising:
a second gate driver that outputs a scanning signal to the second output terminal based on control by the scanning signal controller, wherein
the second gate driver is disposed on the other end side.

12. The display module according to claim 10, wherein
the scanning signal controller inputs a reference clock signal, and
the scanning signal controller controls the first gate driver to synchronize the reference clock signal such that the scanning signal is output.

13. The display module according to claim 11, wherein
the scanning signal controller inputs a reference clock signal, and
the scanning signal controller controls the second gate driver to synchronize the reference clock signal such that the scanning signal is output.

14. The display panel according to claim 1, wherein
the predetermined direction is a longitudinal direction of the display panel.

15. A display device comprising:
a light source; and
a display module comprising:
a display panel, the display panel comprising:
a first scan line disposed in a predetermined direction of the display panel;
a second scan line disposed in the predetermined direction;
a first output terminal provided on one end side of the display panel in the predetermined direction and electrically connected to the first scan line; and
a second output terminal provided on the other end side of the display panel in the predetermined direction and electrically connected to the second scan line.

16. The display device according to claim 15, wherein
the first scan line and the second scan line are disposed in a predetermined number of lines at a time, respectively.

17. The display device according to claim 15, further comprising:
a plurality of pixels aligned in the predetermined direction, pixels adjacent in the predetermined direction are connected to different scan lines, alternating a predetermined number at a time.
